(19) United States
(12) Patent Application Publication
(10) Pub. No.: US 2026/0044728 A1
(43) Pub. Date: Feb. 12, 2026

(54) Optical Intrinsic Neural Networks for Measuring, Aligning, Modeling, and Describing Optical Systems

(71) Applicant: Zibo Hu, Arlington, VA (US)

(72) Inventor: Zibo Hu, Arlington, VA (US)

(21) Appl. No.: 18/800,412

(22) Filed: Aug. 12, 2024

(51) Int. Cl. G06N 3/067; G06N 3/04; G06N 3/08

(52) U.S. Cl. CPC G06N 3/067; G06N 3/04; G06N 3/08

(57) ABSTRACT

The present invention introduces an Optical Intrinsic Neural Network (OINN) for accurately measuring, aligning, modeling, and describing optical systems. This innovative approach combines neural network algorithms with traditional optical theoretical modeling, incorporating layers based on physical formulas. The OINN features optical propagation layers, modulator layers, and detection layers, each with parameters reflecting intrinsic physical meanings and incorporating noise models such as shot noise and thermal noise. The invention includes a method for training the OINN using a specially configured dataset to ensure precise alignment with true physical quantities. This facilitates accurate measurement, calibration, and simulation of complex optical systems, offering a cost-effective and precise solution to traditional challenges in optical system design and analysis.

### BACKGROUND OF THE INVENTION

### Field of the Invention

The present invention relates to the field of optical systems, specifically to methods and systems for measuring, aligning, modeling, and describing optical systems using a novel neural network approach that incorporates intrinsic physical relationships.

### Description of the Related Art

Theoretical understanding of optical systems is now well-developed, and computer simulations can achieve many precise functions within these systems. However, real-world optical systems pose significant challenges due to the need for nanometer-scale precision and the numerous degrees of freedom associated with each optical component. In complex optical systems, where multiple optical elements interact, even minor errors can lead to substantial deviations in output results. At the same time, there is a lack of precise measurement methods to measure intermediate states, making alignment, modeling, and description of complex optical systems challenging.

Traditional methods for measuring, aligning, modeling, and describing optical systems are brute force approaches. It is extremely difficult to measure intermediate states on specific planes, especially on the surfaces of optical components, because even minor errors can lead to significant changes. Achieving nanometer-level accuracy is required, involving not only translational degrees of freedom but also angular degrees of freedom. Traditional alignment methods resemble exhaustive search, involving continuous adjustments of optical components in hopes of matching theoretical design parameters. Due to the lack of monitoring for intermediate states, exhaustively adjusting a complex optical system with numerous interacting degrees of freedom is almost impossible and extremely expensive. While modeling and describing are theoretically straightforward, modeling a real-world optical system is challenging because optical systems are highly sensitive and achieving nanometer-level precision for each component is nearly impossible or prohibitively expensive.

Existing methods for optical system alignment, measurement, and modeling face several limitations:

1. Precision Challenges: Achieving nanometer-scale accuracy is exceedingly difficult. Minor errors can significantly affect the system's output, necessitating extensive and often impractical adjustments.
2. Complex Interactions: In systems with multiple interacting optical elements, the cumulative effect of small deviations can lead to substantial discrepancies, making traditional alignment methods inefficient.
3. Lack of Observational Techniques: Traditional methods often lack the capability to observe the intermediate states of the optical system, which is crucial for accurate alignment and calibration.
4. Cost and Time: Manual iterative adjustments are not only time-consuming but also economically burdensome, especially for high-precision applications.

Given these challenges, there is a need for an innovative, economical, and precise method to measure, align, model, and describe optical systems. The present invention introduces Optical Intrinsic Neural Networks (OINNs), which combine neural network algorithms with traditional optical theoretical modeling. OINNs provide a novel solution by incorporating known physical relationships into the neural network architecture. This ensures accurate measurement of complex optical systems without the need for prohibitively expensive equipment and excessive time consumption. Consequently, it can support efficient alignment, modeling, and description of complex systems.

The OINNs offer an accurate and cost-effective means to describe optical systems, enabling perfect predictions of system outputs and facilitating the construction of more complex optical systems. This approach not only allows for precise measurement of optical system parameters but also provides a detailed description of the system, paving the way for future advancements in complex optical system design and implementation.

### BRIEF SUMMARY OF THE INVENTION

The present invention introduces an Optical Intrinsic Neural Network (OINN) that combines neural network algorithms with traditional optical theory modeling. Unlike conventional neural networks that rely on fully connected layers, convolutional layers, or transform layers, the OINN employs novel neural network layers based on physical formulas to ensure the network architecture incorporates known physical relationships.

The Optical Intrinsic Neural Network (OINN) uses complex optical fields to describe the propagation process, thereby defining the Optical Propagation Layer (FIG. 2). The input, output, and weight parameter matrices within these layers have intrinsic physical meanings. Various noise models, such as the shot noise layer and thermal noise layer, function similarly to nonlinear activation functions and also hold physical significance. This approach ensures that all known physical relationships are embedded within the OINN. A similar method is used to define the Modulator Layer and Observation Layer (FIG. 3, FIG. 4). These layers' input, output, and weight matrices possess real physical meanings, with appropriate noise functions integrated into them, ensuring that known physical relationships are translated into the neural network layers.

Training involves finding intrinsic values, referred to as true physical quantities. The training dataset consists of input-output pairs from optical systems. The OINN achieves the lowest loss when its parameters represent these intrinsic values or true physical quantities. Thus, by using only the input-output pairs, the OINN provides an innovative, economical, and accurate solution for measuring, aligning, modeling, and describing optical systems.

To ensure convergence to a low-loss state, the training set must be specially configured, with each input having a unique output, given the finite observation methods in optical systems.

### BRIEF DESCRIPTION OF THE SEVERAL VIEWS OF THE DRAWING

FIG. 1: This figure provides a schematic diagram of the Optical Intrinsic Neural Network (OINN), illustrating the correspondence between the layers of the neural network and the components of the optical system.

FIG. 2: This figure presents a schematic diagram of the Propagation Layer within the OINN, showing the input, output, and the relationship matrix that defines the layer.

FIG. 3: This figure illustrates the Modulator Layer, detailing their inputs, outputs, and the relationship matrices that define these layers within the OINN.

FIG. 4: This figure illustrates the Detection Layer, detailing their inputs, outputs, and the relationship matrices that define these layers within the OINN.

FIG. 5: This figure shows the application of the Optical Intrinsic Neural Network in describing an optical system, highlighting its accuracy in modeling. It emphasizes how the OINN can scan and determine all system parameters to align simulation results with actual outcomes, facilitating future optical design.

### DETAILED DESCRIPTION OF THE INVENTION

The Optical Intrinsic Neural Network (OINN) is a method that combines neural network algorithms with traditional optical theoretical modeling. Unlike traditional neural networks that rely on empirically constructed layers such as fully connected layers, convolutional layers, and transformer layers, the OINN employs novel neural network layers based on physical formulas. This ensures that the network architecture incorporates known physical relationships, corresponding directly to components of optical systems.

For instance, the optical propagation process is defined as an Optical Propagation Layer, described using complex optical fields. Optical components such as lenses and Spatial Light Modulators (SLMs) are defined as Modulator Layers, and observation devices like cameras are defined as Detection Layers. The parameters within these layers carry intrinsic physical meanings. Additionally, various deviations are modeled using specific functions, such as shot noise functions and thermal noise functions, ensuring all known physical relationships are embedded within the OINN.

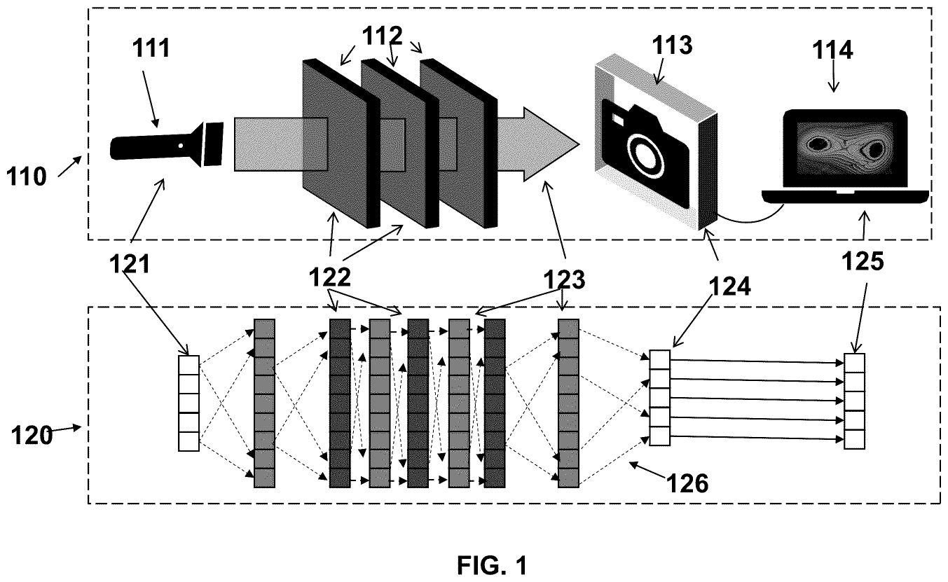

### Components and Correspondence to Optical Systems (FIG. 1)

Typical optical systems 110 consist of an input 111, such as incoming light from a source or another system's output, followed by optical components 112 like lenses, SLMs, phase masks, and filters. These systems end with optical detectors 113, such as cameras, which convert the light into electrical signals fed into a computer as the system output 114. The corresponding relationships within the OINN 120 are as follows:
Input layer 121: Represents the incoming light.
Optical System includes Modulator Layers 122: Represent optical components. Propagation Layers 123: Represent the propagation of optical signals between layers, incorporating noise models similar to activation functions in neural networks 126.
Detection Layer 124: Represents optical detectors.
Output 125: Represents the data received by the computer.

### Layer Descriptions

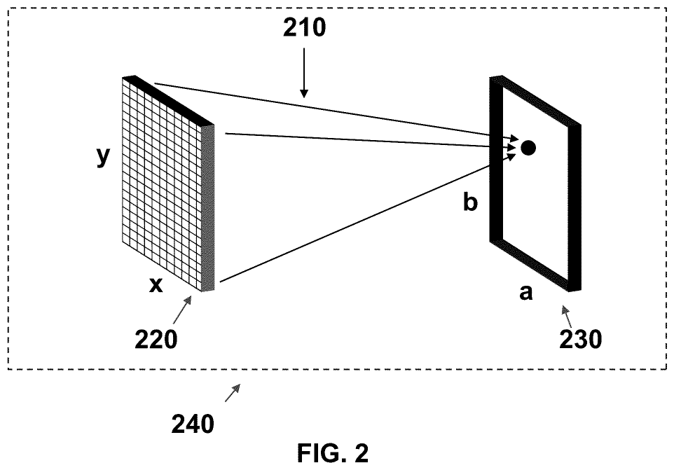

Propagation Layer 240 (FIG. 2): The optical field is represented as a complex optical field, with the input and output planes divided into numerous pixel points. Let IN_{x,y} and OUT_{a,b} represent the input 220 and output planes 230, where x,y are coordinates of the input plane, and a,b are coordinates of the output plane. The transfer matrix for the optical propagation layer is W_{x,y,a,b}. The relationship is given by

$${OUT}_{a , b} = \sum {IN}_{x , y} \cdot {W}_{x , y , a , b} 210$$

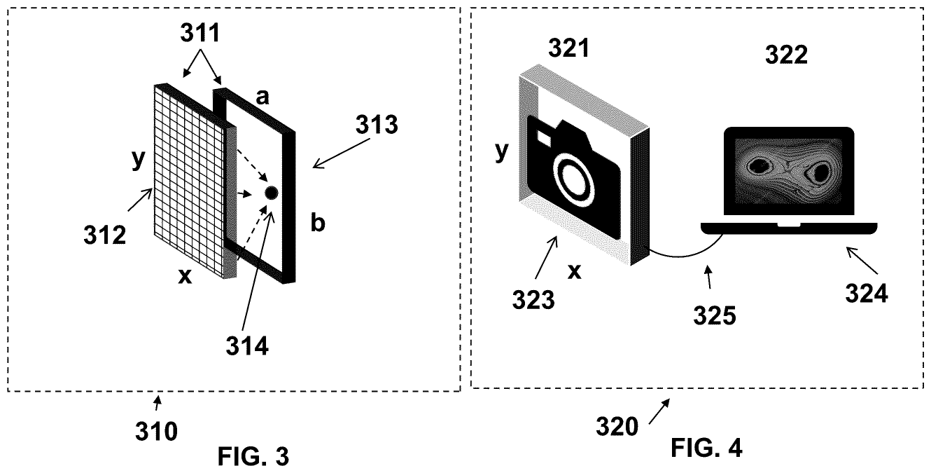

Modulator Layer 310 (FIG. 3): The modulator layer represents optical component 311 using a complex optical field with pixel points IN_{x,y} and OUT_{a,b} as the input plane 312 and output plane 313. The relationship matrix W_{x,y,a,b} involves complex parameters. However, unlike the propagation layer, modulator layers may include nonlinear relationships depending on the type of modulator. The final relationship is:

$${OUT}_{a , b} = f ( \sum g ( {IN}_{x , y} \cdot {W}_{x , y , a , b} ) ) 314$$

where f( ) and g( ) are nonlinear functions.

Detection Layer 320 (FIG. 4): The most common detection layer involves a camera 321, which observes optical intensity and is influenced by thermal noise and shot noise, then transfer data to PC 322 as the output. Here, the input 323 and output planes 324 are the same, represented by IN_{x,y} and OUT_{x,y}. The relationship matrix W_{x,y} involves complex parameters, and the relationship is given by:

$${OUT}_{x , y} = f ( {IN}_{x , y} \cdot {W}_{x , y , a , b} ) 325$$

where f( ) includes noise and nonlinear functions.

### Training the Network

The next step is training the network to find the intrinsic values, referred to as true physical quantities. The training dataset consists of the input and output of the optical system. When all parameters are intrinsic values, the neural network achieves the lowest loss, as the input-output pairs of the training set represent the actual results of the optical system. Zero error is unattainable due to statistical errors in real systems. However, a lower loss indicates that the trained parameters of the OINN closely approximate the true physical quantities. This innovative method uses only the input and output of the optical system to determine various parameters accurately and economically.

The training set must be specially configured so that each output has a unique input. In optical systems, where limited observation methods typically observe optical intensity, inputs can often be non-unique. Therefore, careful selection of the training set is essential to ensure the OINN converges to a low-loss state.

### Application Process

The application process of the OINN involves collecting a specially configured training set with unique input-output pairs, constructing the OINN corresponding to the optical components, and training it to achieve the lowest loss. Extracting the parameters of the trained neural network provides values close to the true physical quantities, achieving accurate measurement and description.

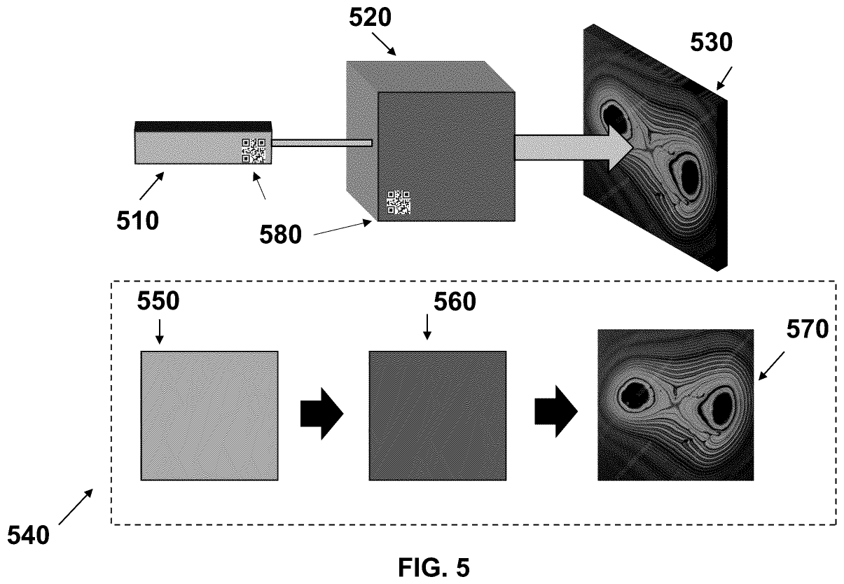

Due to its precise description of real-world optical systems, the OINN can label and tag the system such as using Laser INN 550 to label a laser 510 and OINN 560 to label optical system 520, facilitating more accurate designs of complex multi-system combinations in future optical designs (FIG. 5). This ensures results 570 from the digital simulation 540 align with actual outcomes 530, enabling better preparation for building more sophisticated optical systems. The QR codes 580 can be treated as labels for accurate OINN information for optical system design purposes.

What is claimed is:

1. An Optical Intrinsic Neural Network (OINN) for measuring, aligning, modeling, and describing optical systems, comprising:
an Input Layer configured to receive incoming light;
a plurality of Modulator Layers, each representing an optical component and defined by complex optical fields and parameter matrices with intrinsic physical meanings;
a plurality of Propagation Layers interspersed between said Modulator Layers, each defined by complex optical fields, parameter matrices, and incorporating noise models akin to activation functions in neural networks;
a Detection Layer configured to observe optical intensity and defined by complex optical fields and parameter matrices, including noise models;
an Output Layer configured to provide data received by a computer as system output.

2. The OINN of claim 1, wherein the Input Layer, Modulator Layers, and Detection Layer are configured according to established physical relationships of the optical system components, thereby ensuring precise measurement, alignment, modeling, and description of the optical system.

3. The OINN of claim 1, wherein the Propagation Layer is defined by a transfer matrix W_{x,y,a,b}, such that the output OUT_{a,b} is calculated as:
$${OUT}_{a , b} = \sum {IN}_{x , y} \cdot {W}_{x , y , a , b}$$
Where x, y are the coordinates of the input plane, and a, b are the coordinates of the output plane.

4. The OINN of claim 1, wherein the Modulator Layer incorporates nonlinear relationships specific to different modulators, defined by the equation:
$${OUT}_{a , b} = f ( \sum g ( {IN}_{x , y} \cdot {W}_{x , y , a , b} ) )$$
where f( ) and g( ) are nonlinear functions, x, y are the coordinates of the input plane, and a, b are the coordinates of the output plane.

5. The OINN of claim 1, wherein the Detection Layer includes noise models such as shot noise and thermal noise, defined by the equation:
$${OUT}_{x , y} = f ( {IN}_{x , y} \cdot {W}_{x , y , a , b} )$$
where f( ) includes noise and nonlinear functions, x, y are the coordinates of the input plane, and a, b are the coordinates of the output plane.

6. A method for training the Optical Intrinsic Neural Network (OINN) of claim 1, comprising:
collecting a training dataset consisting of input-output pairs from the optical system;
configuring the OINN with corresponding Input, Modulator, Propagation, and Detection Layers;
training the OINN to minimize the loss between predicted and actual outputs, thereby determining intrinsic values approximating true physical quantities.

7. The method of claim 6, wherein the training dataset is specially configured to ensure each output has a unique input to facilitate convergence of the OINN to a low-loss state.

8. An application process for using the Optical Intrinsic Neural Network (OINN) of claim 1, comprising:
collecting unique input-output training sets;
constructing the OINN corresponding to specific optical components;
training the OINN to achieve the lowest loss;
extracting the parameters of the trained OINN to achieve accurate measurement and description of the optical system.

9. The application process of claim 8, wherein the trained OINN provides an accurate description of the optical system, enabling precise simulation and future optical system design.
